(19) United States
(12) Patent Application Publication
(10) Pub. No.: US 2025/0293730 A1
(43) Pub. Date: Sep. 18, 2025

(54) MULTIPLE-INPUT MULTIPLE-OUTPUT ANTENNA RECEIVER WITH HYBRID ANALOG/DIGITAL BEAMFORMING

(71) Applicants: YEDA RESEARCH AND DEVELOPMENT CO. LTD., Rehovot (IL); TRUSTEES OF BOSTON UNIVERSITY, Boston, MA (US)

(72) Inventors: Yonina ELDAR, Rehovot (IL); Nir SHLEZINGER, Jerusalem (IL); Rabia Tugee Yazicigil KIRBY, Newton, MA (US); Timur ZIRTILOGLU, Allston, MA (US)

(21) Appl. No.: 18/860,160

(22) PCT Filed: May 8, 2023
(86) PCT No.: PCT/IL2023/050466

§ 371 Date: Oct. 25, 2024

Related U.S. Application Data
(60) Provisional application No. 63/339,593, filed on May 9, 2022.

(51) Int. Cl. H04B 7/0413; H04B 1/00

(52) U.S. Cl. CPC H04B 7/0413; H04B 1/0028

(57) ABSTRACT

Some embodiments are directed towards a multiple-input multiple-output (MIMO) receiver system for use with N antennas. The receiver system includes: an analog combiner assembly comprising a matrix of vector modulators applying gain and phase shift to each of N signals being received from the respective antenna and combine said N signals into P corresponding signals, P<N; an array of ADC units, each performing quantization of a respective one of said P corresponding signals with a predetermined bit constrain; and a signal recovery system. The signal recovery system can include a digital signal processor performing task-specific recovery of selected K signals, arriving on the antennas in predetermined input directions, from quantized and filtered digital representation of the N signals being received by the analog combiner assembly; and a control unit. The control unit is adapted to utilize optimized operational data to operate the analog combiner and the digital signal processor.

### CROSS-REFERENCE TO RELATED APPLICATIONS

This application is a national phase filing under 35 C.F.R. § 371 of and claims priority to PCT Patent Application No. PCT/IL2023/050466, filed on May 8, 2023, which claims the priority benefit under 35 U.S.C. § 119 of U.S. Provisional Patent Application No. 63/339,593, filed on May 9, 2022, the content of which is hereby incorporated in its entirety by reference.

### TECHNOLOGICAL FIELD

The present disclosure is generally in the field of antenna receivers and relates to antenna receiver of multiple-input multiple-output (MIMO) type utilizing hybrid analog/digital beamforming.

### BACKGROUND ART

References considered to be relevant as background to the presently disclosed subject matter are listed below:
1. N. Shlezinger and Y. C. Eldar, “On the spectral efficiency of noncooperative uplink massive MIMO systems,” IEEE Trans. Commun. vol. 67, no. 3, pp. 1956-1971, 2018
2. N. Shlezinger, Y. C. Eldar, and M. R. Rodrigues, “Asymptotic taskbased quantization with application to massive MIMO,” IEEE Trans. Signal Process., vol. 67, no. 15, pp. 3995-4012, 2019.
3. S. S. Ioushua and Y. C. Eldar, “A family of hybrid analog-digital beamforming methods for massive MIMO systems,” IEEE Trans. Signal Process., vol. 67, no. 12, pp. 3243-3257, 2019.
4. C. Huang, S. Hu, G. C. Alexandropoulos, A. Zappone, C. Yuen R. Zhang, M. Di Renzo, and M. Debbah, “Holographic MIMO surfaces for 6G wireless networks: Opportunities, challenges, and trends,” IEEE Wireless Commun., vol. 27, no. 5, pp. 118-125, 2020.
5. M. C. M. Soer, E. A. M. Klumperink, D.-J. van den Broek, B. Nauta and F. E. van Vliet, “Beamformer with constant-gm vector modulators and its spatial intermodulation distortion,” IEEE Journal of Solid-State Circuits, vol. 52, no. 3, pp. 735-746, 2017.
6. S. Golabighezelahmad, E. A. Klumperink, and B. Nauta, “A 0.7-5.7 GHZ reconfigurable MIMO receiver architecture for analog spatial notch filtering using orthogonal beamforming,” IEEE J. Solid-State Circuits, 2020
7. J. Mo, A. Alkhateeb, S. Abu-Surra, and R. W. Heath, “Hybrid architectures with few-bit ADC receivers: Achievable rates and energy-rate tradeoffs,” IEEE Trans. Wireless Commun., vol. 16, no. 4, pp. 2274 2287, 2017.
8. K. Roth, H. Pirzadeh, A. L. Swindlehurst, and J. A. Nossek, “A comparison of hybrid beamforming and digital beamforming with lowresolution ADCs for multiple users and imperfect CSI,” IEEE J. Sel. Topics Signal Process., vol. 12, no. 3, pp. 484-498, 2018.
9. J. Choi, J. Sung, B. L. Evans, and A. Gatherer, “Antenna selection for large-scale MIMO systems with low-resolution ADCs,” in 2018 IEEE International Conference on Acoustics, Speech and Signal Processing (ICASSP), 2018, pp. 3594-3598.
10. Y. Li, C. Tao, G. Seco-Granados, A. Mezghani, A. L. Swindlehurst, and L. Liu, “Channel estimation and performance analysis of one-bit massive MIMO systems,” IEEE Trans. Signal Process., vol. 65, no. 15, pp. 4075-4089, 2017.
11. N. Shlezinger, Y. C. Eldar, and M. R. Rodrigues, “Hardware-limited task-based quantization,” IEEE Trans. Signal Process., vol. 67, no. 20, pp. 5223-5238, 2019
12. P. Neuhaus, N. Shlezinger, M. Dörpinghaus, Y. C. Eldar, and G. Fettweis, “Task-based analog-to-digital converters,” IEEE Trans. Signal Process., accepted for publication, 2021.
13. N. Shlezinger and Y. C. Eldar, “Deep task-based quantization,” Entropy, vol. 23, no. 1, p. 104, 2021.
14. S. Salamatian, N. Shlezinger, Y. C. Eldar, and M. Médard, “Task-based quantization for recovering quadratic functions using principal inertia components,” in 2019 IEEE International Symposium on Information Theory (ISIT), 2019, pp. 390-394.
15. H. Wang, N. Shlezinger, Y. C. Eldar, S. Jin, M. F. Imani, I. Yoo, and D. R. Smith, “Dynamic metasurface antennas for MIMO-OFDM receivers with bit-limited ADCs,” IEEE Trans. Commun., vol. 69, no. 4, pp. 2643-2659, 2021
16. N. Shlezinger, R. J. G. van Sloun, I. A. M. Huijben, G. Tsintsadze, and Y. C. Eldar, “Learning task-based analog-to-digital conversion for MIMO receivers,” in ICASSP 2020-2020 IEEE International Conference on Acoustics, Speech and Signal Processing (ICASSP), 2020, pp. 9125-9129.
17. F. Xi, N. Shlezinger, and Y. C. Eldar, “BiLiMO: Bit-limited MIMO radar via task-based quantization,” IEEE Trans. Signal Process., accepted for publication, 2021.
18. P. Skrimponis, S. Dutta, M. Mezzavilla, S. Rangan, S. H. Mirfarshbafan, C. Studer, J. Buckwalter, and M. Rodwell, “Power consumption analysis for mobile mmwave and sub-thz receivers,” in 2020 2nd 6G Wireless Summit (6G SUMMIT), 2020, pp. 1-5.
19. N. Shlezinger, J. Whang, Y. C. Eldar, and A. G. Dimakis, “Model-based deep learning,” arXiv preprint arXiv: 2012.08405, 2020.
20. T. Chen, X. Chen, W. Chen, H. Heaton, J. Liu, Z. Wang, and W. Yin, “Learning to optimize: A primer and a benchmark,” arXiv preprint arXiv: 2103.12828, 2021.
21. V. Monga, Y. Li, and Y. C. Eldar, “Algorithm unrolling: Interpretable, efficient deep learning for signal and image processing,” IEEE Signal Process. Mag., vol. 38, no. 2, pp. 18-44, 2021.
22. S. Khobahi, N. Shlezinger, M. Soltanalian, and Y. C. Eldar, “LoRDNet: Unfolded deep detection network with low-resolution receivers,” IEEE Trans. Signal Process., accepted for publication, 2021.
23. K. Kibaroglu and G. M. Rebeiz, “A 0.05-6 ghz voltage-mode harmonic rejection mixer with up to 30 dbm in-band iip3 and 35dbchrr in 32 nm soi cmos,” in 2017 IEEE Radio Frequency Integrated Circuits Symposium (RFIC), 2017, pp. 304-307.
24. H. J. Qian, B. Zhang, and X. Luo, “High-resolution wideband phase shifter with current limited vector-sum,” IEEE Transactions on Circuits and Systems I: Regular Papers, vol. 66, no. 2, pp. 820-833, 2019.
25. Nir Shlezinger and Yonina C. Eldar, “Task-based quantization with application to MIMO receivers”, Communications in Information and Systems, Volume 20, Number 2, 131-162, 2020.
26. Abbas Khalili et al., “MIMO Networks With One-Bit ADCs: Receiver Design and Communication Strategies”, IEEE Transactions on Communications, Vol. 70, No. 3, March 2022.
27. Tierui Gong et al., “RF Chain Reduction for MIMO Systems: A Hardware Prototype”, IEEE Systems Journal, 2020.
28. Y. C. Eldar, Sampling Theory: Beyond Bandlimited Systems. Cambridge University Press, 2015.
29. M. C. M. Soer, E. A. M. Klumperink, B. Nauta, and F. E. van Vliet, “Spatial interferer rejection in a four-element beamforming receiver front-end with a switched-capacitor vector modulator,” IEEE J. SolidState Circuits, vol. 46, no. 12, pp. 2933-2942, 2011.
30. H. Krishnaswamy and L. Zhang, “Analog and RF interference mitigation for integrated MIMO receiver arrays,” Proc. IEEE, vol. 104, no. 3, pp. 561-575, 2016.
31. J. Poojary et al., “6.4 A 1-to-3 GHz Co-Channel Blocker Resistant, Spatially and Spectrally Passive MIMO Receiver in 65 nm CMOS with +6 dBm In-Band/In-Notch BldB,” 2021 IEEE ISSCC.
32. M. Bajor et al., “A Flexible Phased-Array Architecture for Reception and Rapid Direction-of-Arrival Finding Utilizing Pseudo-Random Antenna Weight Modulation and Compressive Sampling,” IEEE JSSC, vol. 54, no. 5, 2019.
33. L. Zhang et al., “Arbitrary Analog/RF Spatial Filtering for Digital MIMO Receiver Arrays,” IEEE JSSC, vol. 52, no. 12, 2017.

Acknowledgement of the above references herein is not to be inferred as meaning that these are in any way relevant to the patentability of the presently disclosed subject matter.

### BACKGROUND

Multiple-input multiple-output (MIMO) systems utilize multiple antennas and signal acquisition chains, facilitating multiuser communications with increased spectral efficiency and better coverage via beamforming. These systems use large antenna arrays at both transmitter and receiver terminals to perform beamforming and spatial multiplexing.

Widespread utilization of MIMO communications brings superior data capacity, improved coverage, and highly robust multi-user support [1]

MIMO receivers typically include multiple signal acquisition chains for spatial signal processing. Each signal acquisition chain has a radio-frequency (RF) front end performing RF signal amplification with low noise and then down converting this RF signal to low baseband frequencies. This continuous-time analog signal in the baseband is translated to the digital domain for further processing. Analog-to-digital conversion is performed in two steps: the continuous-time analog signal is sampled and converted to a discrete-time signal and then quantized into a discrete-amplitude representation stored as digital bits. This process is usually carried out in hardware using uniform scalar analog-to-digital converters (ADCs). MIMO systems traditionally apply brute-force data acquisition with spatial signal processing using high-resolution quantization and Nyquist sampling rates leading to high power consumption and hardware design complexity, especially in massive MIMO.

MIMO systems are typically costly to implement and consume high power. A common approach to mitigate the increased cost of MIMO receivers is to utilize fewer RF chains and ADCs than antenna elements via hybrid analog/digital beamforming (HBF) approach. Such architectures incorporate an additional analog combiner circuit before the quantization, allowing dimensionality reduction [3] while preserving the ability of the MIMO array in achieving directed beamforming via, e.g., holographic techniques [4]. In fact, HBF is also utilized without RF chain reduction to boost pre-acquisition spatial interferer rejection [5]. Nonetheless, the introduction of an analog combiner comprised of active components may also be power-hungry. An additional power reduction technique is to use low-resolution acquisition, connecting each antenna to a low-quantization rate ADC [7]-[10]. However, the distortion added by coarse quantization results in degraded signal recovery.

Recently, a task-based quantization framework was introduced to design MIMO receivers utilizing bit-constrained ADCs [11]-[14], while achieving accurate signal recovery. Despite numerically evaluated performance gains, implementing MIMO receivers utilizing task-based quantization requires an analog pre-processing front end which is typically costly and power-hungry.

### GENERAL DESCRIPTION

As described above, MIMO systems utilize multiple antennas and signal acquisition chains, facilitating multiuser communications with increased spectral efficiency and better coverage via beamforming. MIMO systems are typically costly to implement and consume high power. A commonly used method to reduce the cost of MIMO receivers is to design hybrid analog/digital beamforming (HBF), which reduces the number of RF chains. However, the added analog circuitry involves active components whose consumed power may surpass that saved in RF chain reduction. An additional method to realize power-efficient MIMO systems is to use low resolution analog-to-digital converters (ADCs), however, compromising signal recovery accuracy.

There is therefore a need in the art for a novel approach of MIMO receiver architecture utilizing a power-efficient design methodology for task-specific operation, enabling the antenna receiver to recover desired signals from the multiple signals to which the antenna is exposed, and significantly reduce power consumption.

The present disclosure provides an optimized MIMO receiver system characterized by power-efficient operation with dedicated beamforming to mitigate spatial interferers in congested environments, utilizing low-quantization rate ADCs, jointly optimizing the analog and digital processing using task-specific quantization techniques. The optimized receiver system of the present disclosure utilizes an efficient analog pre-processing hardware architecture utilizing vector modulators preprogrammed and/or operated by optimized operational data to enable high-quality recovery of desired signals arriving to multiple antennas while suppressing undesirable interferers.

Preferably, the vector modulators are sparse low-resolution modulators, enabling to reduce analog processing power while maintaining recovery accuracy. Supported by numerical simulations and power analysis, the optimized power-efficient MIMO receiver system of the present disclosure achieves comparable signal recovery performance to power-hungry fully-digital MIMO receivers using high-resolution ADCs. Furthermore, the optimized receiver system of the present disclosure outperforms the task-agnostic HBF receivers with low-quantization rate ADCs in recovery accuracy at lower power.

The receiver system of the present disclosure is configured to implement bit-constrained signal recovery. As described above, the antenna receiver of the present disclosure utilizes analog combiners implemented using vector modulators (VMs). Vector modulator is one of most common integrated phase shifters, typically implementing a phase control range of 90°. The input signal is divided into two paths with 90° (In-phase/Quadrature) offset, which are amplitude weighted by VGAs (Variable Gain Amplifiers) or attenuators, and finally combined.

According to the present disclosure, the VMs are preferably either discrete or sparsely activated. Since the power consumption is directly proportional to utilized hardware complexity [18], the use of such VMs in the analog combiner assembly enables significant reduction of power consumption.

The inventors propose a task-specific optimization technique co-integrating these hardware-level techniques to achieve an accurate and power-efficient recovery of the desired task information. In addition, the inventors present a hardware architecture utilizing low-resolution ADCs and a programmable analog pre-processing front end. By developing a model for end-to-end system evaluation, the performance of the optimized receiver system of the present disclosure is compared against task-agnostic MIMO systems in terms of signal recovery accuracy and receiver beam pattern via numerical simulations.

The inventors also provide power consumption estimates for the optimized and benchmark receiver systems derived from the measured power consumption of the state-of-the-art (SOA) hardware implementations.

At a significantly reduced quantization rate, it is shown that the optimized receiver system of the present disclosure achieves accurate signal recovery comparable to the performance of the fully-digital MIMO receivers using high-resolution ADCs. Furthermore, the optimized task-specific receiver system notably outperforms such task-agnostic architectures operating under similar bit constraints. Regarding beam pattern, the inventors demonstrate that the optimized receiver system attenuates the interferers by ≥36 dB. It is shown that the optimized task-specific receiver of the present disclosure reduces the power consumption by at least 58% compared to task-agnostic fully-digital MIMO and HBF receivers.

Thus, according to one broad aspect of the present disclosure, it provides a multiple-input multiple-output (MIMO) receiver system associated with N antennas, the receiver system comprising:
an analog combiner assembly comprising a matrix of vector modulators configured for coupling to said N antennas, said analog combiner assembly being configured and operable to controllably apply gain and phase shift to each of N signals being received from the respective antenna and combine said N signals into P corresponding signals, P<N;
an ADC assembly comprising an array of ADC units, each configured for performing quantization of a respective one of said P corresponding signals with a predetermined bit constrain;
a signal recovery system comprising: a digital signal processor configured to perform task-specific recovery of selected K signals associated with predetermined input directions to which the N antennas are exposed from quantized and filtered digital representation of the N signals being received by the analog combiner assembly; and a control unit, wherein
said control unit is configured and operable to utilize optimized operational data to operate the analog combiner and the digital signal processor utilize, wherein said optimized operational data is indicative at least of optimized values of the phase shifts, such that said digital signal processor utilizes said optimized values of the phase shifts to perform said task-specific signal recovery under a condition of minimal value of a mean square error characteristic minimizing a difference between said digital representation of the signals being received by the analog combiner assembly and said selected K signals.

It should be noted that, depending on the discrete dictionary of the VM (which comes from its hardware limitations), either only phase shifts or both phase shifts and gain are optimized.

The optimized operational data of the matrix of the vector modulators provides that said quantized and filtered digital representation of the N signals is characterized by rejection of undesired signals incident on the N antennas and corresponds only to the selected K signals associated with the predetermined input directions to which the N antennas are exposed.

Preferably, the optimized operational data is further indicative of an optimized sparsity level of deactivation of said matrix of vector modulators, said digital signal processor utilizing said optimized sparsity level of deactivation during said task-specific signal recovery, such that power consumption is reduced. More specifically, the optimization procedure takes into account the sparsity level of VMs operation to minimize overall loss measure of the analog combiner.

In some embodiments, the array of ADCs comprises P complex ADCs, each of the ADCs comprising in-phase and quadrature-phase quantization channels, the array of the ADCs thereby defining 2P quantization channels.

In some embodiments, the control unit is configured and operable to communicate with a signal recovery optimizer to receive therefrom and store said optimized operational data. Alternatively or additionally, the control unit is configured and operable to communicate with a signal recovery optimizer to receive therefrom and store said optimized operational data.

In some embodiments, the control unit comprises a signal recovery optimizer configured and operable to generate said optimized operational data. The signal recovery optimizer may be configured and operable to utilize input data, which comprises system data and comprises measured data indicative of said N signals being received, and utilize predetermined task-specific data defined by said condition of the minimal value of the mean square error, to perform an optimization process and determine at least the optimized values of the phase shifts, and generate the optimized operational data for the analog combiner and the digital signal processor.

The signal recovery optimizer is further configured and operable to utilize said input data and said predetermined task-specific data to perform the optimization process and determine the optimized values of the phase shifts (and possible also gain) of vector modulators, and preferably also optimized sparsity level of deactivation of said matrix of vector modulators, and generate the optimized operational data for the analog combiner and the digital signal processor.

The system data may comprise: number N of the antennas, number P of the ADCs and a value b of said predetermined bit constrain defining a quantization resolution of the ADC, a matrix arrangement N×P of said matrix of vector modulators, and angles of arrival θ₁, . . . , θ_{K} and power level of said K signals, and angles ϕ₁, . . . , ϕ_{M} of arrival of M undesired signals to be rejected.

It should be noted that, typically, each element of the N×P analog combiner matrix A corresponds to the vector modulator in the hardware, i.e. there is a one-to-one mapping between computed A matrix and VMs, each of them corresponding to a particular element in matrix A.

The signal recovery optimizer may be configured and operable to iteratively determine at least the optimized values of the phase shifts via iterative tuning of said values, to thereby determine the optimized operational data satisfying the condition of MSEₘᵢₙ. Preferably, the iterative tuning is implemented via convex optimization processing to satisfy said condition for the MSE defined as:

$$MSE ( A ) := 𝔼 \{ {‖ s - 𝔼 \{ s \vert {Q}_{b} ( A x ) \} ‖}^{2} \}$$

where [symbol] {s|_{b}(Ax)} is conditional expectation value of a signal vector s of said selected K signals having the digital representation Q_{b}(Ax), wherein said convex optimization is performed over discrete values in a parametric space of phase shifts performed by the vector modulators, thereby performing discrete optimization aimed at minimizing overall loss measure [symbol] (A) of the analog combiner.

The signal recovery optimizer is further configured and operable to iteratively determine optimized sparsity level of deactivation of the vector modulators via iterative tuning of said sparsity level, to thereby determine the optimized operational data satisfying the condition of MSEₘᵢₙ.

The signal recovery optimizer is typically configured as a computer system comprising input and output utilities and a data processor and analyzer utility. In some embodiments of the present disclosure, the data processor and analyzer utility comprises: an analog combiner controller comprising a beamforming optimizer, and a task controller, wherein the task controller is configured and operable to determine, for each signal being received, a value of the mean square error, and the beamforming optimizer is configured and operable to operate together with the task controller to iteratively determine the optimized values of the phase shifts via the iterative tuning of said values, to thereby determine the optimized operational data satisfying the condition of MSEₘᵢₙ.

Preferably, the data processor and analyzer utility of the signal recovery optimizer further comprises a power optimizer configured and operable to operate together with the task controller to iteratively determine the optimized sparsity level via the iterative tuning of said sparsity level utilized in determination of the optimized operational data.

Generally, the optimization is aimed at improving the vector modulators' resolution and interference suppression. The use of relatively high (fine) resolution VMs provides better system performance and thus less iterative tuning stages are required, while use of low (coarse) resolution VMs requires more iterative tuning stages.

For example, as will be described below, 4-bit VM resolution (16 states) was found to be enough to provide 58% reduction in power compared to task-agnostic MIMO architectures using high-resolution VMs. In order to achieve better interference suppression at arbitrary angles, more optimization computations are to be used. Numerical results of the simulations and experiments conducted by the inventors have shown more than 36 dB of suppression.

As described above, the optimization may include, and in some embodiments preferably includes, that associated with the sparsity level of VMs. The use of VMs with relatively high sparsity level requires more optimization. For example, as will be described below, for N=8 and P=2, numerical empirical results have shown minimum sparsity level of 0% and maximum operating sparsity level, sufficient for recovery to be 25% for 4-bit ADC recovery. Overall numerical results have showed 58% system power reduction compared to conventional solutions.

According to another broad aspect of the present disclosure, it provides a signal recovery optimizer for optimizing operation of a multiple-input multiple-output (MIMO) receiver system, which is associated with N antennas and which comprises an analog combiner formed by a matrix of vector modulators and comprises an array of ADCs performing signal quantization with a predetermined bit constrain, and is configured to perform hybrid analog-digital beamforming of N signals being received and corresponding to K desired signals arriving to the antennas with predetermined angles from respective desired sources, and perform signal recovery of said K signals, wherein said signal recovery optimizer comprises a computer system configured and operable to utilize input data comprising system data, measured data indicative of the N signals being received, and predetermined task-specific data defined by a task-specific condition of a minimal value of a mean square error characteristic minimizing a difference between digital representation of the signals being received by the analog combiner assembly and said K desired signals, and perform an iterative optimization process to determine at least optimized operational data for said analog combiner indicative of optimized values of phase shifts, thereby enabling the signal recovery of said K signals while optimizing performance of the antenna receiver by suppressing effect of undesired M interferers arriving to the antennas.

As described above, the system data may comprise: number N of the antennas, number P of the ADCs and a value b of said predetermined bit constrain defining a quantization resolution of the ADC, a matrix arrangement N×P of said matrix of vector modulators and mapping [symbol] ^{N×P} between the computed A matrix and the vector modulators, and angles of arrival θ₁, . . . , θ_{K} and power level of said K desired signals, and angles ϕ₁, . . . , ϕ_{M} of arrival of said M undesired signals.

The computer system of the signal recovery optimizer may be configured and operable to iteratively determine the optimized values of the phase shifts via iterative tuning of said values to thereby determine the optimized operational data satisfying the condition of MSEₘᵢₙ.

Preferably, the computer system is further configured and operable to perform iterative optimization process for a sparsity level of deactivation of the vector modulators (e.g., via iterative tuning of said sparsity level), such that the optimized operational data is further indicative of optimized sparsity level of deactivation, thereby reducing power consumption of the analog combiner.

The iterative tuning may be implemented via convex optimization processing to satisfy said condition for the MSE defined as:

$$MSE ( A ) := 𝔼 \{ {‖ s - 𝔼 \{ s \vert {Q}_{b} ( A x ) \} ‖}^{2} \}$$

The computer system of the signal recovery optimizer typically includes input and output utilities and a data processor and analyzer utility. The data processor and analyzer utility may comprise: an analog combiner controller comprising a beamforming optimizer, and a task controller, wherein the task controller is configured and operable to determine, for each signal being received, a value of the mean square error, and the beamforming optimizer is configured and operable to operate together with the task controller to iteratively determine the optimized values of the phase shifts via the iterative tuning of said values, to thereby determine the optimized operational data satisfying the condition of MSEₘᵢₙ.

The data processor and analyzer utility may further comprise a power optimizer configured and operable to operate together with the task controller to iteratively determine optimized sparsity level via iterative tuning of said sparsity level.

In some embodiments, the signal recovery optimizer is configured and operable to connect to the antenna receiver to perform a learning session and determine the operational data; and/or is configured and operable for communication with a control unit of the antenna receiver to communicate the operational data to be stored in the control unit.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting example only, with reference to the accompanying drawings, in which:

FIG. 1A schematically illustrates the configuration and operation of an antenna receiver system of the present disclosure with embedded beamforming and low-quantization rate ADCs;

FIGS. 1B and 1C illustrate, respectively, a block diagram of the configuration a signal recovery system of the present disclosure for use in or with the receiver system, and a flow diagram of the signal recovery system operation to optimize the receiver system performance;

FIGS. 2A and 2B show more specifically the configuration of exemplary receiver systems equipped with the optimizer system of the present disclosure, where the figures illustrate the analog combiner hardware architecture;

FIGS. 2C to 2I exemplify the configuration of the analog combiner showing more specifically the RF front-end details, the circuit level implementation of the receiver's blocks, Constant-Gm noise-cancelling VM complex gain constellation for 15 and 8 slices, and the system- and VM-level reconfigurability for input impedance, gain, and noise analysis;

FIGS. 3 and 4A-4B show the results of simulations performed by the inventors, wherein FIG. 3 shows the Mean Square Error (MSE) characteristic of antenna receivers vs. total number of quantization bits for recovering two desired signals (K=2) in the presence of two spatial interferers (M=2); FIGS. 4A-4B show array factor (AF) plots vs. angle of arrival for 2 outputs (P=2) (dB scale, 20 log), wherein FIG. 4A shows array factor for output 1; and FIG. 4B shows array factor for output 2;

FIGS. 5A-5C show the measurement/experimental results obtained by the inventors; and

FIG. 6 shows the summary table which compares the performance of the task-specific receiver system of the present disclosure to some of the state-of-the-art approaches described in the literature.

### DETAILED DESCRIPTION OF EMBODIMENTS

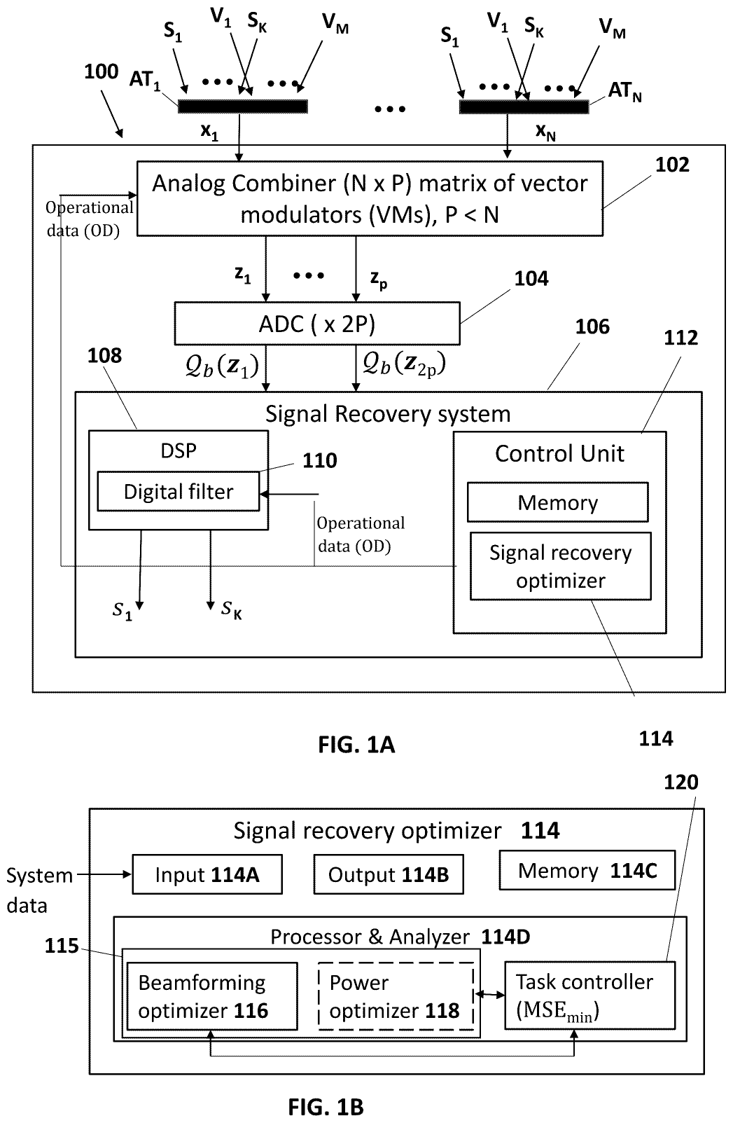

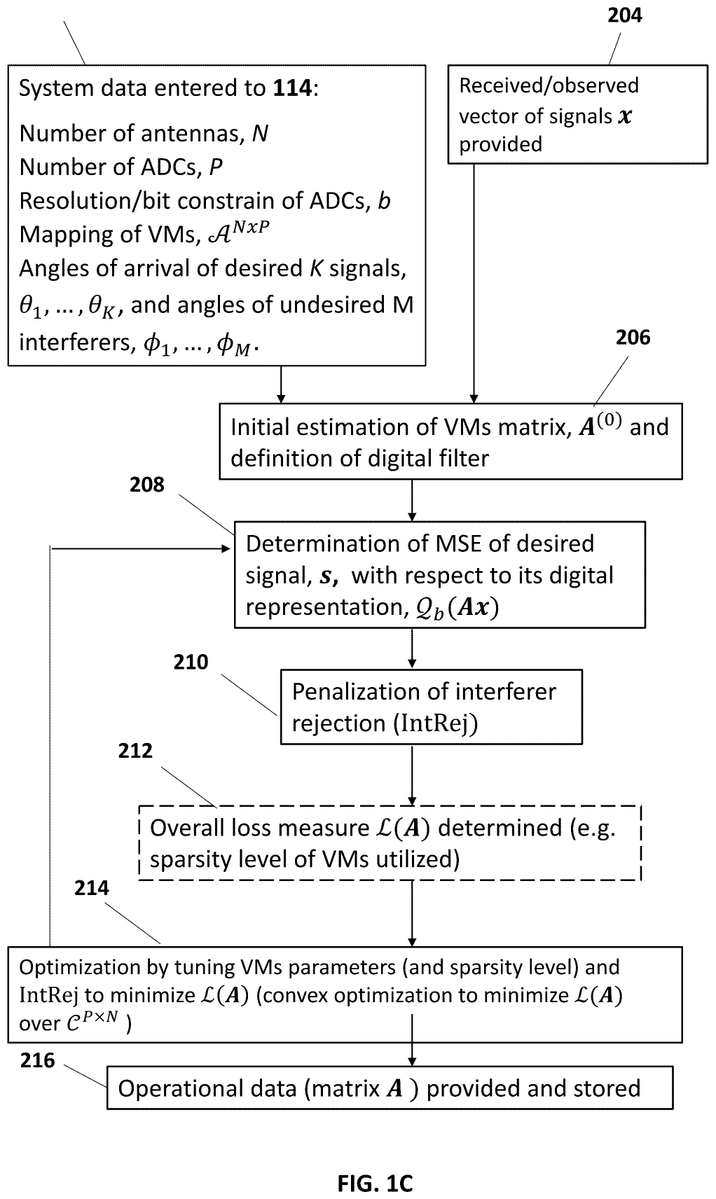

Reference is made to FIG. 1A showing schematically a receiver system 100 of the present disclosure configured as a hybrid analog-digital receiver of the MIMO type. The receiver 100 is an electronic system associated with an array of N antennas AT₁, . . . . AT_{N}. Each antenna is exposed to a plurality of (K+M) signals including K desired signals S₁, . . . . S_{K} coming from a corresponding plurality of K desired directions (associated with desired sources) and to M undesired signals V₁, . . . . V_{M} coming from undesired directions/sources, as well as interfering signals, and environment noise signal, which all relate to category of “undesired signals”.

The receiver 100 is configured to reconstruct the desired signals S₁, . . . . S_{K} while rejecting the undesired ones. What is actually received/observed by the receiver system 100 from each antenna is a combined signal being a linear combination of the (K+M) signals to which the respective antenna is exposed. Thus, the receiver observes signals X₁, . . . , X_{N} from the N antennas.

The receiver system 100 includes an analog combiner assembly 102, an ADC assembly 104, and a signal recovery module/system 106. The signal recovery module 106 includes: a digital signal processor (DSP 108 including a digital filter 110); and a control unit 112.

According to the present disclosure, the receiver system 100 is configured and operable according to a specific/predetermined task aimed at optimizing recovery/reconstruction of the desired K signals S₁, . . . . S_{K} (from the variety of signals to which the antennas are exposed), while rejecting the undesired signals, and also optimizing the power consumption of the system (i.e., of the analog combiner assembly and the ADCs).

To this end, the receiver system 100 utilizes the analog combiner assembly 102 of the type including a matrix of P×N vector modulators (VMs), the ADC assembly includes a plurality of low-resolution ADCs, i.e., ADCs performing signal quantization with a predetermined bit constrain, and the control unit 112 includes a signal recovery optimizer 114, the configuration and operation of which will be described further below. Generally, the signal recovery optimizer 114 defines optimized operational data indicative of optimized operational parameters of the VMs matrix of the analog combiner assembly 102 which are used by the DSP 108 (e.g., for setting the digital filter 110) to perform the task-specific signal recovery under a condition of minimal value of a mean square error characterizing a difference between digital representation of the signals being received by the analog combiner assembly and the selected/desired K signals. Such optimized operational parameters of the VMs include phase shift values applied by the VMs. The optimized operational parameters may further include, or in some embodiments preferably further includes, sparsity level of the VMs) (deactivation of the VMs).

As exemplified in the figure, while being not specifically shown here, the ADC assembly may include the plurality of P complex ADCs whose inputs are coupled to mixers and which include in-phase and quadrature-phase quantization channels. More specifically, as will be exemplified further below, each signal output of the V_{M} is transformed (downconverted by mixer) into in-phase and quadrature signal components, both entering the respective one of the two corresponding channels of the ADC, thus providing together 2P quantization channels.

The signals being received by the analog assembly 102 are combined into relatively low-dimensional signals z₁, . . . , z_{P}, P<N, making thus the number of RF chains, and, hence, the number of inputs processed in the digital domain, smaller than the number of antennas. Such a matrix of analog phase shifters (e.g., vector modulators) that change the relative phases of the signals is used for beamforming.

The use of low-resolution ADCs limits the number of bits utilized by the ADC assembly 106, which thus operates under quantization constraints. This, in combination with sparsity level of BMs deactivation if used, is crucial to keep cost and power consumption of massive MIMO system feasible.

It should be noted that the signal recovery optimizer 114 can operate once or periodically to perform the optimization of the system parameters enabling the receiver system to use the optimized operational parameters in association with the given antenna set (analog combiner, ADC assembly and DSP module). To this end, the signal recovery optimizer 114 can be connectable (via wires mor wireless data communication) to the control unit 112 of the antenna receiver system 100 to perform a learning and optimization session (as will be described further below) and the respective optimized operational parameters are stored in a memory of the control unit 112 (or in a local controller of the analog combiner), thus resulting in an optimized receiver system. Hence, the signal recovery optimizer 114 may be a structural part of the control unit 112 of the antenna receiver 100 (as exemplified in FIG. 1A) or may be connectable thereto for the optimization session.

Reference is made to FIGS. 1B and 1C showing configuration of the signal recovery optimizer 114 and a flow diagram 200 of its operation to optimize operation of the functional modules of the antenna receiver, i.e., analog combiner assembly 102, and ADC and DSP units 104 and 108. The signal recovery optimizer 114 is generally configured as a computerized circuit including data input and output utilities 114A and 114B, memory 114C, and data processor and analyzer utility 114D.

Input data is provided to the signal recovery optimizer 114 (step 202) which includes system data including the following: number N of antennas, number P (or 2P) of the ADCs and their quantization rate/resolution b, matrix N×P of VMs, and desired angles of arrival θ₁, . . . , θ_{K} of desired K signals (directions to desired sources) and power level (LNA), as well as angles ϕ₁, . . . , ϕ_{M} of undesired M interferers. This system data is either estimated or externally provided by a spatial sensor.

The input data to the signal recovery optimizer 114 also includes measured signal data (step 204) which includes vector of signals being observed by the receiver (from the N antenna elements (antennas)), x=[x₁, . . . , X_{N}]^{T}, where each xᵢ corresponds to a set s of K desired signals, s=[s₁, . . . , S_{K}]^{T} and a set v of M interfering signals, v=[v₁, . . . , v_{M}]^{T}. It should be understood that each i-th observed/received signal xᵢ is a certain function of the signals to which the respective i-th antenna is exposed (which arrive thereon), fᵢ(s₁, . . . , s_{K}, v₁, . . . , v_{M}).

The processor & analyzer 114D includes an analog combiner controller 115 including beamforming optimizer 116, and includes a task controller 120. The beamforming optimizer 116 is configured and operable to determine such optimized operational data of the analog combiner assembly 102 as phase shift values (phase shifters and adders) to be used by each V_{M} for optimizing channel estimation accuracy.

The processor analyzer preferably also includes a power optimizer 118. The power optimizer 118 is configured and operable to determine such optimized operational data of the analog combiner 102 as an optimized pattern of VMs deactivation (i.e. sparsity level) to provide optimal discrete or sparsity of the analog combiner operation (optimally increasing the sparsity level of signal reading mode of the VMs).

The task controller 120 is configured and operable to determine, for each i-th antenna from the N antennas, a difference between the DSP output (quantized and filtered digital representation of the i-th signal Xᵢ observed by the receiver) and the corresponding desired signals (S_{K})ᵢ being incident on the i-th antenna. Such a difference can be evaluated as mean square error (MSE) of the processing implemented by the functional modules of the receiver system 100. The task controller 120 operates to vary and select the optimized operational data of the VNs (at least the optimized values of the phase shifts as described above) aimed at minimizing the MSE, i.e., determine the operational parameters satisfying the condition of MSEₘᵢₙ. This will be described more specifically below. It should be noted that the ADCs' configuration (bit constrain b) can also be optimized to implement non-subtractive dithered quantization contributing to minimization of MSE.

However, it should be noted that practical numerical implementation showed that dithering might not be required for quantization and not necessarily improve performance at all cases, and may thus be used optionally.

As shown in FIG. 1C, the input data is analyzed (by the data processor and analyzer 114D) to perform initial estimate of the VMs matrix, A⁽⁰⁾, and define the digital filter 110 (see Eq. (8) below)—step 206. As described above and will be described more specifically further below, the operational data of the vector modulators is defined by the N×P matrix, A_{N×P}, of vector modulators, where the matrix values, A_{1,1} . . . . A_{N,P}, correspond to e.g., complex gain and phase shifts The data processor and analyzer 114D (i.e. its task controller 120) operates to utilize the initial combiner matrix to determine the MSE for the desired signal, s, with respect to its digital representation, Q_{b}(Ax), where Q_{b}(⋅) is an element-wise uniform quantization operator with b levels—see Eq. (5) below (step 208). Then, the task controller 120 and the beamforming optimizer 116 operate to perform penalization of interferer rejection (IntRej)—step 210. As will be described further below (see Eq (6) below), this is implemented via the max norm of AA_{ϕ}, ∥AA_{ϕ}∥ₘₐₓ (where A_{ϕ} is the steering matrix of the interfering set v), using regularization coefficient γ_{I}≥0.

Preferably, the power optimizer 118 is also used, and the task controller 120 and the power optimizer 118 operate to utilize the sparsity level of the VMs to determine overall loss measure L(A)—step 212. To this end, ∥A∥_{1,1} is used where ∥⋅∥_{1,1} is the entry-wise l₁ norm operator, using regularization coefficient γ_{S}≥0—see Eq (9) below.

Then, the optimization process proceeds by performing (by the task controller 120) convex optimization to minimize L(A) over C^{P×N} (C denoting the set of all complex numbers), by operating the beamforming procedure performed by the vector modulators (and preferably also the power optimizer) to tune the operational parameters of the VMs including phase shift values (and preferably also sparsity level (i.e., deactivation pattern)), and also performing adjustment of IntRej (step 214). As will be described more specifically further below, the iterative tuning is implemented via convex optimization processing to satisfy the condition for MSEₘᵢₙ defined by Eq (5), such that the convex optimization is performed over discrete values in a parametric space of phase shifts performed by the vector modulators, thereby performing discrete optimization aimed at minimizing overall loss measure L(A) of the analog combiner. Iteration steps 208 to 214 are repeated until the task-specific condition of MSEₘᵢₙ is obtained, and the corresponding operational data (values of the parameters being tuned/adjusted) is provided and stored (step 216).

Hence, according to the present disclosure, in order to execute the task-specific signal recovery, the control unit 112 of the receiver system 100 includes the signal recovery optimizer 114 and/or utilizes the optimization data (optimized operational data OD) provided by the signal recovery optimizer and stored in the system memory) to tune the analog combiner assembly 102 to operate with the optimized phase shift values of the VMs to thereby providing optimized signal recovery output s\hat{ }₁ . . . . S\hat{ }_{K} to satisfy the task-specific condition of MSEₘᵢₙ for the signal recovery, and preferably to operate with optimized sparsity level to provide, together with low-resolution ADCs, the required power efficiency (reduced power consumption).

Thus, the present disclosure provides a novel task-specific quantization system which converts the received analog signals, X₁ . . . . X_{N}, corresponding to signals to which N antennas are exposed, into digital representations thereof, Q_{b}(z1) . . . . Q_{b}(zp), in a manner which preserves the semantic information required to carry out the desired task, rather than recovering the analog signal, thus allowing to operate efficiently with standard ADCs under relatively tight bit constraints. The inventors have shown that task-specific quantization achieves notably improved accuracy in recovering the desired task compared to conventional digital-only methods operating under the same bit budget. Moreover, the technique of the present disclosure utilizes a dedicated beamforming to mitigate spatial interferers in congested environments, utilizing low-quantization rate ADCs and jointly optimizing the analog and digital processing using task-specific quantization techniques.

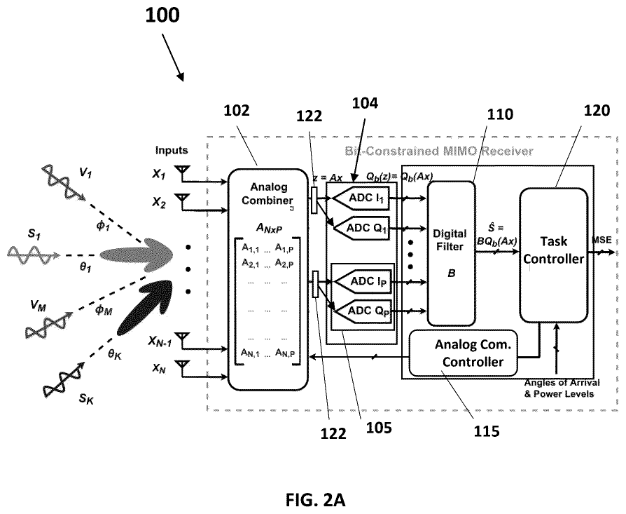

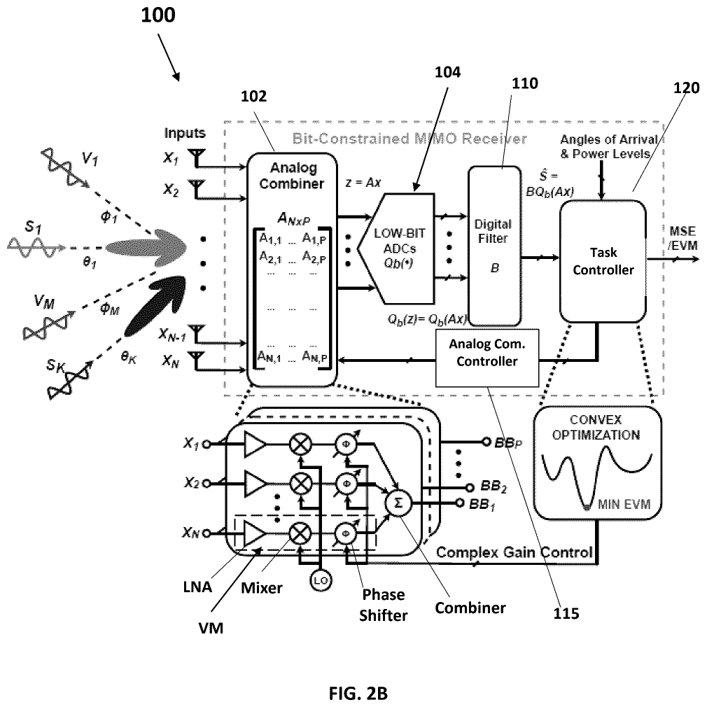

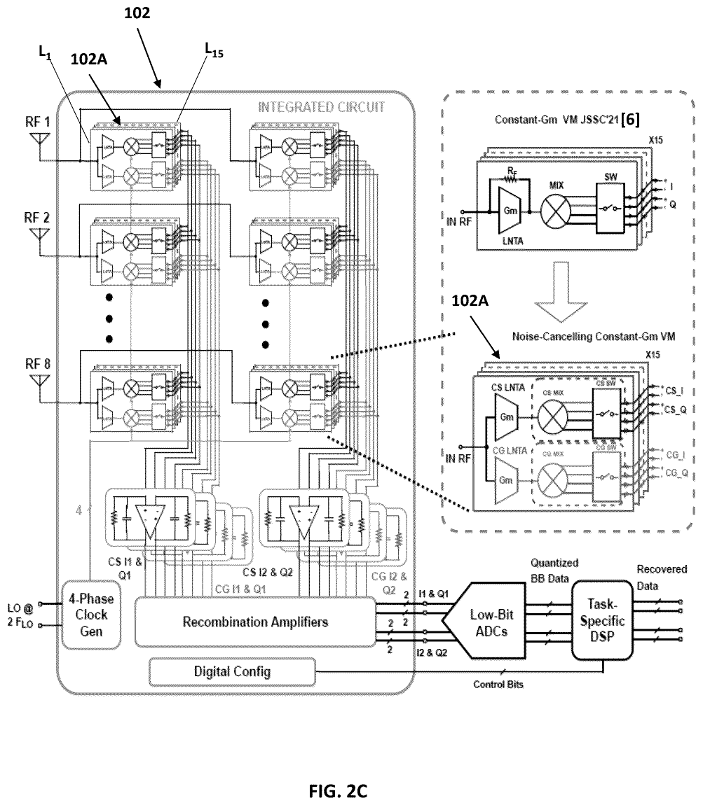

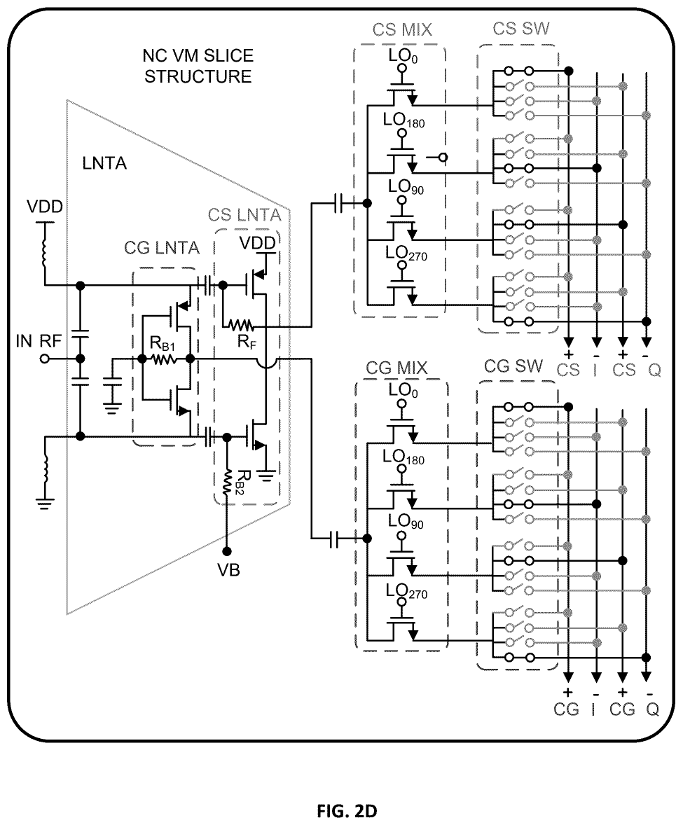

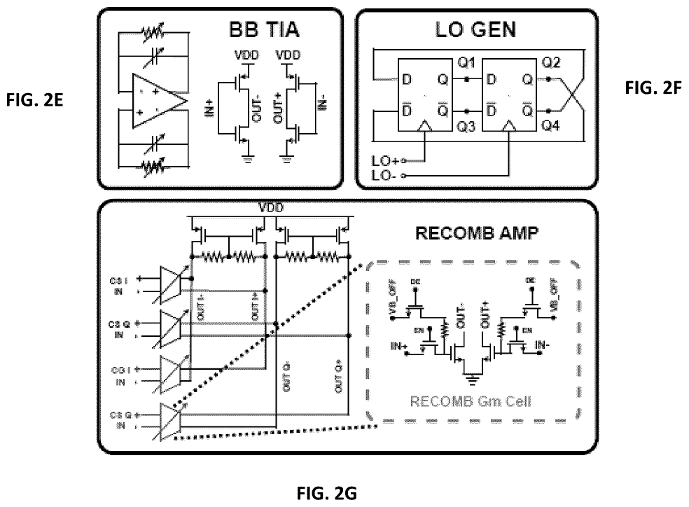

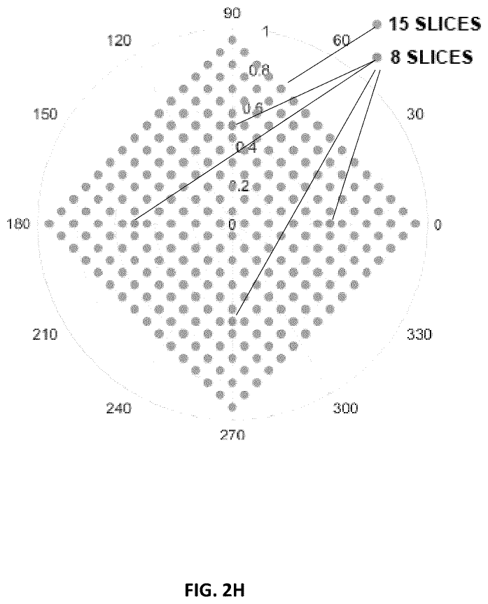

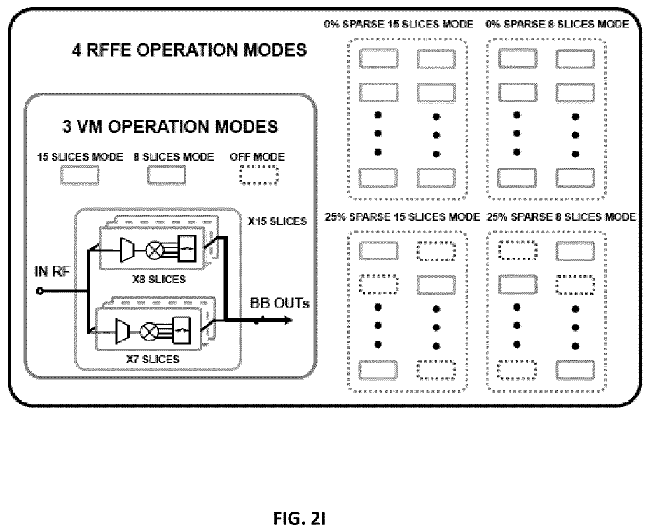

Reference is made to FIG. 2A showing more specifically the receiver system configuration and optimization procedure. To facilitate understanding, the same reference numbers are used to identify the functionally similar components of all the examples of the presently disclosed subject matter.

The receiver system 100 of FIG. 2A is associated with N antennas AT₁ . . . . AT_{N} and is configured similar to that of FIG. 1A to implement embedded beamforming and low-quantization rate ADCs. The system 100 includes: analog combiner assembly 102 formed by the matrix of vector modulators; ADC assembly 104 including an array of ADCs; and a signal recovery module 106 including DSP 108, and control unit 112 which includes a signal recovery optimizer (task controller 120 and analog combiner controller 115). The signal recovery optimizer is configured and operable to set the operational parameters to enable task-specific recovery of signals to which antenna is exposed, as described above.

The analog combiner 102 observes/receives input signals X₁, . . . . X_{N}, each corresponding to a combination of (K+M) signals to which each antenna is exposed including: K desired signals S₁ . . . . S_{K} coming from desired sources at relative angles θ₁, . . . , θ_{K}, respectively, and undesired signals V₁ . . . . V_{M} coming from undesired sources at angles ϕ₁, . . . , ϕ_{M}, respectively (interferer, noise, etc.).

As shown in the figure, A_{N×P}, is the N×P matrix of vector modulators, where the matrix values, A_{1,1} . . . . A_{N,P}, correspond to e.g. complex gain and phase shifts. As also shown in the figure, the ADC assembly 104 includes the plurality of P complex ADCs 105 whose inputs are coupled to mixers 122 and which include in-phase and quadrature-phase quantization channels. Each signal output of the VM is transformed (downconverted) by mixer 122 into in-phase and quadrature signal components, both entering the respective one of the two corresponding channels of the ADC 105, thus providing together the array of 2P quantization channels, forming P ADCs for quantization of in-phase signal components, ADC I₁ . . . . ADC Iₚ, and P ADCs for quantization of quadrature signal components, ADC Q₁ . . . . ADC Qₚ. It is understood, although not specifically shown here, that the analog combiner assembly 102 also typically includes mixers for downconversion of the analog combined signals being received to the low baseband frequency thus producing the in-phase and quadrature-phase signal components (I & Q).

The signal recovery optimizer includes a task controller 120 which utilizes input data (system data) about the number of antennas, desired angles of arrival, power levels of signals being received, ADC resolution (number of bits), b, and mapping of the VMs matrix A dictated by the hardware, etc., and determines the task-specific characteristics, i.e., minimal achievable MSE.

It should be understood that mapping of the VMs actually relates to association/assignment between the elements of the N×P analog combiner matrix A and arrangement of the VMs. Typically, each element of the N×P analog combiner matrix A corresponds to a VM in the hardware, i.e. there is a one-to-one mapping between computed A matrix and VMs, each of them corresponding to a particular element in A.

It should be noted that the values of the operational parameter(s), i.e., phase shifts and possibly also gain shifts, of the analog combiner elements (vector modulators) are configured from the resulting optimization (operational data provided by the control unit 112). The values of analog combiner matrix (configurations of VMs) may either take values from a set of continuous number or from a discrete finite dictionary, defined by hardware limitations. Also, sparse low-resolution vector modulators can be used to reduce analog processing power while maintaining recovery accuracy. From the power consumption point of view, the VMs can be boosted to be either discrete or sparsely activated (since the power consumption is directly proportional to utilized hardware complexity).

FIG. 2B illustrates the similar MIMO receiver system 100 more specifically showing the hardware architecture of the analog combiner 102 suitable to be used in the receiver system of the present disclosure. As shown the analog combiner 102 includes N×P vector modulators, generally at 102A, all associated with/coupled to P combiners, generally at 102B. The vector modulator 102A includes a low noise amplifier (LNA), mixer performing downconversion, and phase shifter. The signal being output from the combiner has baseband frequency, such that P baseband frequency signals BB₁, . . . . BB_{P} are output form the analog combiner 102.

As also shown in the figure, and will be described further below, the task controller 120 is configured and operable to perform convex optimization of the operational parameters of the analog combiner to minimize error vector magnitude (EVM) performance, while successfully suppressing undesired blockers in the spatial domain via beamforming.

Reference is made to FIGS. 2C to 2G which exemplify the configuration of the analog combiner showing more specifically the RF front-end details. FIG. 2C exemplifies the matrix of vector modulators of the analog combiner 102, and compares, in the dashed-lined box, the configuration of the vector modulator 102A with noise cancellation circuit according to the present disclosure, to the conventional approach as described in reference [6].

As shown in FIG. 2C, in this specific not-limiting example, the analog combiner has the 8×2 matrix of vector modulators, i.e. has eight inputs and two baseband outputs. The so-obtained sixteen VMs are implemented with highly-reconfigurable noise-cancelling Constant-Gm VMs performing matrix-vector multiplication, downconversion, and summation in the current domain followed by baseband transimpedance amplifiers (TIAs) and recombination amplifiers (with 6-bit control) for noise cancellation. The receiver system also has an on-chip 25% dutycycle clock generator, operating from external clock input, and a digital configuration block to control the operation. The baseband outputs are digitized off-chip for offline task-specific recovery using two bits.

As also shown in FIG. 2C and also in FIGS. 2E-2G (showing circuit level implementation of the receiver's blocks), each VM includes 15 identical downconversion slices, L₁, . . . . L₁₅, employing a low-noise transconductance amplifier (LNTA) with common-gate (CG) and -source (CS) stages for noise cancellation, a current-mode quadrature downconversion mixer, and switches that direct quadrature differential baseband current outputs of each slice towards one of the four directions. Effectively, each slice performs a 90° phase shift.

Cartesian combining is achieved by binary grouping of the slices, resulting in a constellation as shown in FIGS. 2H and 2I. FIG. 2H shows Constant-Gm noise-cancelling VM complex gain constellation for 15 and 8 slices, and FIG. 2I shows the system- and VM-level reconfigurability for input impedance, gain, and noise analysis, as described below. Since the VMs can be configured to any value in the available dictionary, they are capable of performing for both task-specific and -agnostic modes. One of the drawbacks of the conventional approach is associated with the fact that the input impedance depends on the feedback resistor value of the LNTA, hence, tightly coupling input matching to gain and noise figure performance. The technique of the present disclosure overcomes this drawback by decoupling the input matching from noise figure by leveraging CG and CS stages for noise cancellation. The present disclosure extends the noise-cancellation technique that was previously demonstrated for single-element receivers to the analog combiner matrix implementation (8×2VM).

Input Impedance & Gain: Similar to the conventional noise-cancelling topologies, CG devices are used for impedance matching. Since there are two VMs with 15 slices connected to a 50Ω antenna (R_{S}), single-slice CG transconductance 1/G_{m,CG} can be calculated as G_{m,CG}=0.66 mS. Inverter-based amplifiers were used both for CG and CS to boost the Gm/la. It is also important to note that output impedances of both CG and CS LNTAs are relatively high as compared to conventionally used since the feedback resistors of both CG and CS are now decoupled from input matching requirements, thus, improving the overall gain. The overall gain (A) is set by the total gain of CG and CS LNTAs, current-mode passive mixer gain loss, TIA gain (A_{TIA}), and recombination network gain.

Noise Analysis: To evaluate noise performance of the system, the inventors considered the following noise contributors: CS feedback resistance noise (V_{n, out, RF}), CG and CS transistor noise, and baseband processing circuitry noise (V_{n, out, BB}). Noise factor expression given by

$${F}_{N C} = {K}_{fold} [ 1 + \frac{{V}_{n , out , RF}^{2}}{{A}^{2} \overline{{V}_{n , Rs}^{2}}} + \frac{\begin{matrix}γ {G}_{m , C S} {A}_{TIA , C S} + \\ γ {{G}_{m , C G} ( {A}_{TIA , CG} δ - {R}_{S} {G}_{m , C S} {A}_{TIA , C S} )}^{2}\end{matrix}}{{A}^{2} {R}_{s}} ] + \frac{\overline{{V}_{n , out , BB}^{2}}}{{A}^{2} \overline{{V}_{n , RS}^{2}}}$$

Here, K_{fold} accounts for the passive mixer noise folding, showing that by choosing the appropriate value of the recombination factor δ (implemented using 6-bit controlled amplifiers), CG noise contribution can be minimized, while CS noise performance is improved by a high feedback resistor value.

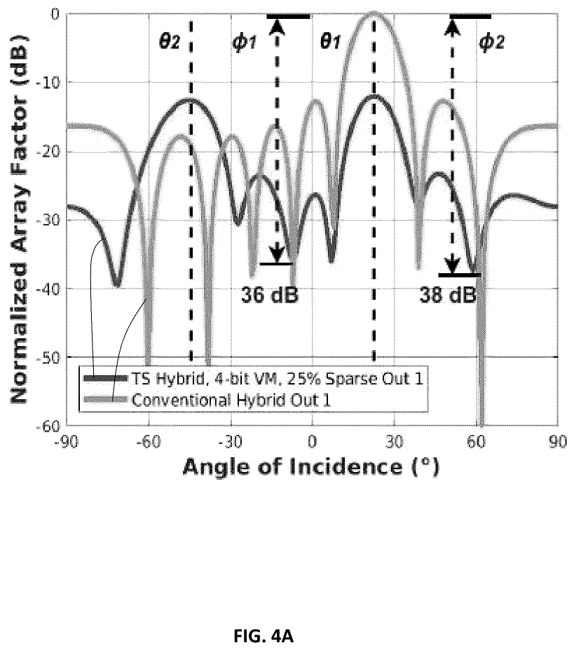

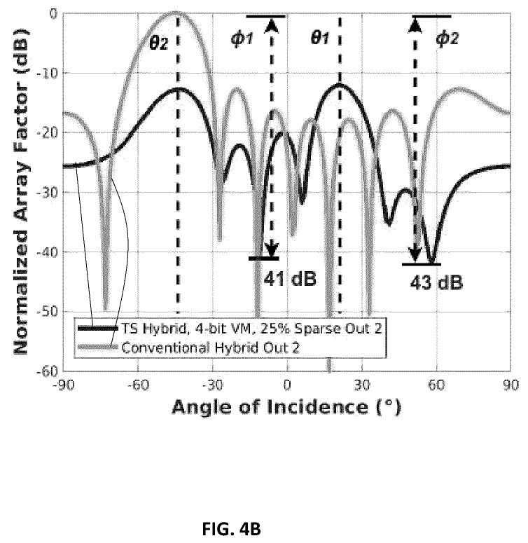

Receiver system reconfigurability: In addition to complex gain and phase configuration through VM, the inventors introduced additional techniques for reducing the RF front end power consumption by leveraging the task-specific approach: 1) VM quantization can be adjusted from 15 slices (fine quantization with high resolution, 256 points) to 8 slices (coarse quantization with low resolution, 4 points), resulting in the constellations shown in FIGS. 2H and 2I, and FIG. 2C) sparsifying the analog combiner matrix A, which is equivalent to maintaining a sleep mode for selected VMs. To exploit the sparsity of VMs, the bias voltage of the CS NMOS device is controlled as shown in FIGS. 2D-2G. The CG LNTA is always on for input impedance matching. Since the CG LNTA consumes 7×lower power than the CS LNTA, always-on CG LNTA does not result in a significant power consumption overhead. Passive mixer drivers are also disabled for the slices in sleep mode for further power savings. The receiver system reconfigurability enables four operational modes as shown in FIG. 4: (1) 15-slices (SL) 0% sparse (SP) mode, (2) 15-SL 25% SP mode, (3) 8-SL 0% SP mode, and (4) 8-SL 25% SP mode. The desired VM resolution and sparsity levels are provided by the task-specific signal-processing algorithm for accurate task recovery.

The following is the description of the principles underlying the operation of the signal recovery optimizer described above.

Let us consider a hybrid MIMO receiver system with N antenna elements and P RF chains and ADCs. Let x=[x₁, . . . , X_{N}]^{T} be signal observed/received by the receiver system (by the analog combiner) corresponding to signals incident on the N antenna elements. The received signal x is first processed in analog, yielding the vector z=[z₁, . . . , z_{P}]^{T}, which is forwarded to the ADCs. Let A be the P×N analog pre-processing matrix, and the output vector z is

$$z = Ax . \qquad ( 1 )$$

The vector z is converted to a digital representation using P identical uniform ADCs, each with b levels, i.e., the overall number of bits used is P[log₂ b]. The resulting vector processed in digital domain is Q_{b}(z), where Q_{b}(⋅) is the element-wise uniform quantization operator with b levels.

Turning back to FIG. 1A or FIG. 2, the received vector x incorporates a set of K desired signals, denoted by S₁, . . . , S_{K}, received from sources at relative angles θ₁, . . . , θ_{K}, respectively. In addition, the received vector also includes M interferer components v₁, . . . , v_{M} received from sources at relative angles ϕ₁, . . . , ϕ_{M}, respectively. All sources are assumed to be narrowband and lying at the far-field, and thus the noisy received signal is given by

$$x = {\sum }_{k = 1}^{K} {s}_{k} a ( {θ}_{k} ) + {\sum }_{m = 1}^{M} {v}_{m} a ( {ϕ}_{m} ) + w . \qquad ( 2 )$$

In Eq. (2), w is additive white Gaussian noise with variance σ_{w}², and a(θ) is the N×1 steering weights vector whose entries are given by

$${[ a ( θ ) ]}_{n} = {e}^{- j 2 π n \frac{d}{λ} s i n ( θ )} \qquad ( 3 )$$

where d is the element spacing and λ is the wavelength.

By defining the steering matrices A_{θ}∈C^{N×K} and A_{ϕ}∈C^{N×M} (C denoting the set of all complex numbers) such that [A_{θ}]_{n,k}=[a(θₖ)]ₙ and [A_{ϕ}]_{n,m}=[a(ϕₘ)]ₙ, as well as s=[s₁, . . . , S_{K}]^{T} and v=[v₁, . . . , v_{M}]^{T}, Eq. (2) can be written as

$$x = {A}_{θ} s + {A}_{ϕ} v + w \qquad ( 4 )$$

Based on Eq. (4), the second-order statistical moments of the observed signal x is

$${C}_{x} = {A}_{θ} {C}_{s} {A}_{θ}^{H} + {A}_{ϕ} {C}_{v} {A}_{ϕ}^{H} + {σ}_{w}^{2} {I}_{N} ,$$

while its correlation with the task of interest (signal s) is given by

$${C}_{s x} = {C}_{s} {A}_{θ}^{H} .$$

Here, Cₛ and Cᵥ denote the covariance matrices of s and v, respectively, and A_{θ}^{H}, A_{ϕ}^{H} are Hermitian transposes of the respective matrices. These statistical measures are utilized for the task-specific recovery problem.

The goal of the technique of the present disclosure is to tune the analog combiner A of the HBF MIMO receiver system based on the signal model in Eq. (4). The present disclosure provides a design of the receiver system which is optimized simultaneously for multiple tasks, including (i) accurate signal recovery, (ii) spatial interferer suppression, and (iii) power efficiency.

With regards to signal recovery, the main task of the optimized receiver system is to recover the desired signal s from the digital representation Q_{b}(z). The design measure here is the mean-squared error (MSE) being a characteristic (design objective) for the signal recovery defined by a difference between the digital representation of the signals x being received by the analog combiner assembly and the desired signals s to which the antenna is exposed. The MSE is defined by

$$M S E ( A ) := E \{ {‖ s - E \{ s \vert {Q}_{b} ( A x ) \} ‖}^{2} \} \qquad ( 5 )$$

where E{s|Q_{b}(Ax)} denotes the conditional expectation value of the desired signal s given the digital representation Q_{b}(Ax).

With regards to interferer suppression, the MSE characteristic/objective focuses only on the ability to recover desired signals s. As such, it may prefer settings of A in which the effect of undesired signals v is mitigated via digital processing. In practice, it is often preferable to reject interferers in the analog domain. The strong spatial interferers may lead to receiver desensitization and increased dynamic range requirement of ADCs. Consequently, in the optimized receiver system, the analog combiner is to be optimized to suppress the spatial interferers. Since the contribution of undesired signals v on the analog combiner output z takes the form AA_{ϕ} (through substitution of Eq. (4) in Eq. (1)), interferer rejection is penalized via the max norm of AA_{ϕ}, i.e.,

$$IntRej ( A ) := {‖ {AA}_{ϕ} ‖}_{max} = {max}_{i , j} ( \vert {[ {AA}_{ϕ} ]}_{i , j} \vert ) . \qquad ( 6 )$$

With regards to power efficiency, the power consumption of MIMO receiver front end is dictated by the individual cost of each hardware component, including local oscillators generation (LO Gen), RF amplifiers, mixers, filters, and ADCs. The use of low-resolution quantizers notably reduces the ADC power consumption, which is approximately proportional to the number of levels b.

In the present disclosure, the inventors consider the design of the analog combiner A implemented using vector modulators (VMs). When using VMs, the elements of analog combiner A cannot take any value in the set C of all complex numbers and are constrained to some discrete set A⊂C, including 0∈A, i.e., when VM is deactivated. In this case, the power consumption of the analog combiner A is highly dependent on two factors: how many different values can its entries take, i.e., |A|, and which of its entries are active, namely, the sparsity level of A. If the sparsity level of A increases while reducing its resolution, i.e., using a coarse A, the power consumption of the receiver significantly reduces.

In the following, the operation of the signal recovery optimizer of the present disclosure is described providing an end-to-end design algorithm of operation for the optimized HBF MIMO receiver system. The inventors consider the case where the number of ADCs, their resolution b, and mapping of the VMs matrix A are dictated by the hardware and optimize the analog combiner matrix A accordingly.

The technique of the present disclosure takes advantage of the task-based quantization setup studied in reference [11] for recovering matrix A which minimizes the MSE per Eq. (5). It has been shown in [11] that while minimizing Eq. (5) is likely to be analytically intractable, one can obtain accurate signal recovery by modeling the ADCs as implementing non-subtractive dithered quantization, while aiming to recover the linear minimal MSE estimate of s, i.e., the digital processing outputs an estimate of the form s\hat{ }=BQ_{b}(Ax) for some B∈C^{K×P}.

To formulate the MSE objective under the above considerations, let us define Γ≙CₛₓCₓ^{-1/2}, and let {λ_{Γ,i}} be its singular values arranged in descending order. Also, set

$$κ {=}^{△} {{η}^{2} ( 1 - \frac{{η}^{2}}{3 {b}^{2}} )}^{- 1} ,$$

where η is a coefficient tuned to guarantee negligible overloading probability of the ADCs (set here to η=3).

The MSE can now be reformulated in Eq. (5) as stated in the following lemma (adapting [11, Lem. 1] to complex signals):

Lemma 1. When the ADCs utilize non-subtractive dithered quantizers with vanishing overloading probability, the MSE objective Eq. (5) becomes:

$$MSE ( A ) = Tr ( Γ {C}_{x} {Γ}^{H} - Γ {C}_{x} {{A}^{H} ( A {C}_{x} {A}^{H} + \frac{2 κ \cdot Tr ( A {C}_{x} {A}^{H} )}{3 {b}^{2} \cdot P} {I}_{P} )}^{- 1} {AC}_{x} {Γ}^{H} ) \qquad ( 7 )$$

This MSE is achieved by setting the digital filter to be

$$B ( A ) = Γ {C}_{x} {{A}^{H} ( A {C}_{x} {A}^{H} + \frac{2 κ \cdot Tr ( A {C}_{x} {A}^{H} )}{3 {b}^{2} \cdot P} {I}_{P} )}^{- 1} \qquad ( 8 )$$

While Lemma 1 rigorously holds under some limiting assumptions on the system operation, i.e., using non-subtractive dithered quantizers, it also approximately holds when these assumptions are not satisfied for a broad range of input signals [11]. Furthermore, as shown in [11], the MSE objective in Eq. (7) is convex.

In the following, this convexity is exploited to incorporate additional design considerations such that A is optimized while meeting the requirements/goals of the technique of the present disclosure described above.

The MSE objective of Eq. (7) admits a closed-form minimizer, see [11, Theorem. 1]. However, such a design only considers the signal recovery task and does not impose any structure on A. To account for the interference rejection requirement and to balance the power consumption of the analog circuitry, the design objective is formulated as

$$L ( A ) = M S E ( A ) + {γ}_{I} IntRej ( A ) + {γ}_{S} {‖ A ‖}_{1 , 1} . \qquad ( 9 )$$

In Eq. (9), ∥⋅∥_{1,1} is the entry-wise l₁ norm operator, while γ₁, γ_{S}≥0 are regularization coefficients, balancing the contribution of signal recovery MSE, spatial interferer rejection, and sparsity level of analog combiner in the overall loss measure L(A). The interferer rejection regularization term defined in Eq. (6) is convex, while sparsity of A is boosted in a manner that preserves convexity by adding the entry-wise l₁ norm.

The final consideration which is not accounted for in Eq. (9) is the usage of discretized VMs. The resulting optimization is thus formulated as

$$A ° = {argmin}_{A ∈ {A}^{P \times N}} L ( A ) . \qquad ( 10 )$$

The fact that the optimization problem in Eq. (5) is formulated over a discrete (i.e., non-convex) search space makes obtaining the analog combiner that optimizes the objective within the constrained set extremely challenging. Thus, the present disclosure utilizes the convex optimization performed over discrete values in a parametric space of phase shifts performed by the vector modulators, thereby performing discrete optimization aimed at minimizing overall loss measure/objective L(A) of the analog combiner. Nonetheless, as the objective L(A) is convex, one can utilize discrete optimization to recover suitable designs of A, as described below.

Since the optimization problem in Eq. (10) seeks to minimize a convex objective over a discrete set, the inventors tackle it using projected convex optimization. The design strategy is comprised of kₘₐₓ rounds of a convex optimizer for minimizing L(A) over C^{P×N}, with periodic projections onto the discrete A. The inventors use O_{L}(⋅) to denote the iterative optimizer with loss measure L. By using proximal gradient descent with step-size μ>0 while treating L^{˜}(A):=MSE (A)+γ_{I}IntRej (A) as the task term and ∥A∥_{1,1} as the prior, thus guaranteeing sparsity of the analog combiner, it holds that

$${O}_{L} ( A ) = arg {min}_{{A}^{∼} ∈ {C}^{P \times N}} {γ}_{S} {‖ {A}^{\to } ‖}_{1 , 1} + \frac{1}{2} {‖ {A}^{∼} - A + μ {∇}_{A} {L}^{∼} ( A ) ‖}_{2 , 2}^{2} = {T}_{γ s} \{ A - μ {∇}_{A} ( MSE ( A ) + {γ}_{I} IntRej ( A ) ) \} \qquad ( 11 )$$

Here, T is the element-wise complex soft-thresholding operator, given by T_{λ}(z):=e^{jarg (z)}max (|z|−λ, 0). Every kₚᵣₒⱼ iterations, the intermediate A^{(k)} is projected to account for the discrete VMs via the element-wise projection operator P_{A}(z):=arg min_{a∈A}∥a−z∥₂. The resulting process (data processing technique) is summarized below as Process 1.

The main hyperparameters of Process 1 are the regularization coefficients γ₁, γ_{S}, the iteration limits kₘₐₓ, kₚᵣₒⱼ, and the initial setting of A⁽⁰⁾. These add up to the individual hyperparameters of the convex optimizer O_{L}(⋅). In the experimental study conducted by the inventors, where the number of complex ADCs is equal to the number of desired sources, i.e., P=K, A⁽⁰⁾=Γ was used as the initial estimate, and the digital filter was set via Eq. (8).

Process 1 allows tuning (optimizing) of the HBF receiver system to accurately carry out signal recovery and interferer rejection tasks while boosting low-power implementation. Further below it is shown that by utilizing Process 1 to optimize operation of a task-specific HBF receiver system utilizing low resolution ADCs (i.e., ADCs with certain bit constrain) and analog combiner formed by quantized VMs with sparsity, comparable or improved MSE can be achieved compared to task-agnostic HBF receivers, while consuming half the power at a 4×reduced quantization rate.

Process 1: Analog combiner setting

| Init: Fix A⁽⁰⁾ | |
|---|---|
| 1 for k = 1,2, ... , kₘₐₓ do | |
| 2 | Update A^{(k)} ← O_{L}(A^{(k-1)}) |
| 3 | if mod(k, kₚᵣₒⱼ ) = 0 then |
| 4 | Project via A^{(k)} ← P_{A}(A^{(k)}) |
| 5 | end |

6 end
Output: Analog combiner A^{(k}^{ₘₐₓ}⁾.

The tuning/optimization of the analog combiner is implemented using system data, i.e. prior knowledge of the angle of arrivals and power levels. These are used to form the correlation matrices Cₓ and Cₛₓ used by the optimization process. This information is either estimated or externally provided by a spatial sensor.

In the simulations performed by the inventors, the hyperparameters of Process 1 were manually selected. However, it should be understood that deep learning tools can be used to design data-driven hyperparameter setting via, e.g., the learn-to-optimize framework [20] or via deep unfolding [21]. The latter was recently shown in [22] to be particularly suitable for realizing accurate and fast optimization of convex objectives over discrete sets.

In the following, evaluation of the optimized MIMO receiver system is described.

A task-specific MIMO hardware system is modeled to evaluate performance improvements compared to task-agnostic MIMO receivers and estimate power savings from the proposed task-specific quantization techniques. The hardware of the receiver system includes an RF analog-combiner front end and digital signal processing (DSP) back end for task-specific recovery similar to the receiver system shown in FIG. 1A or FIG. 2. The RF analog-combiner front end 102 includes reconfigurable VMs with low noise, each assigned to a value of a specific matrix A entry. For an N×P front end, a total of N×P VMs are utilized. The receiver system is configured using the prior knowledge of the angle of arrivals and signal power as described above. The optimized coefficients of the analog-combiner matrix A (defining the optimized phase shift values) are determined according to Process 1 in the DSP back end (by signal recovery optimizer 114), and the VMs are configured using the analog combiner controller. The N-element input observations x=[x₁, . . . , X_{N}]^{T} are fed into the analog combiner at RF frequencies, downconverted to a low baseband frequency, and provided to the low-quantization rate ADCs as in- and quadrature-phase signals (I & Q). In the digital domain, the filter B, computed using Eq. (8), is applied and signal recovery is performed. Performance is characterized using MSE.

For the simulations, the inventors consider an 8×2 hybrid MIMO receiver system, with K=2 desired signals at angles

$$θ = \frac{π}{8} , {θ}_{2} = - \frac{π}{4}$$

with variances 1.5 and 0.5, respectively. Additionally, the inventors model M=2 unwanted interferers at angles

$${ϕ}_{1} = - \frac{π}{18} , {ϕ}_{2} = \frac{π}{3}$$

with variances 5 for both sources. Consequently, the interferers are several times stronger than the desired signals. The noise level is set to σ_{w}²=1. For comparison purposes, the inventors also evaluate the performance of the system without any quantization. In addition, a task-agnostic 8×2 conventional hybrid MIMO receiver is modeled with beamforming in analog and recovery in digital, and a task-agnostic 8×8 fully-digital MIMO receiver recovering the data solely in the digital domain, as benchmark systems.

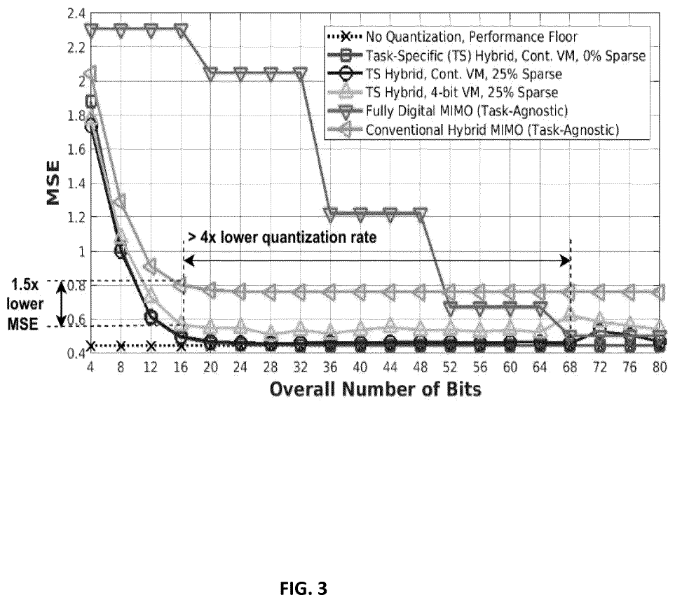

The inventors evaluate the signal recovery MSE performance achieved using Process 1 for various levels of analog pre-processing matrix A sparsity and VM resolution. The MSE in recovering signals s versus the overall number of bits, i.e., P[log₂b], is depicted in FIG. 3. The numerical simulation results are shown for sparsity levels of 0 and 25% with non-quantized, continuous (Cont.) matrix A, and for 25% sparse matrix A with VMs quantized with relatively low resolution, e.g., 4-bit resolution. It is observed in FIG. 3 that by utilizing optimization process (Process 1 above), an optimized task-specific hybrid MIMO receiver system can be configured using low-quantization rate ADCs to approach the MSE performance achieved without any quantization, while using low-resolution VMs, e.g., merely 2⁴=16 different settings for 4 bits, and deactivating 25% of VMs for sparsity to reduce power.

The task-agnostic fully-digital MIMO receiver achieves substantially worse MSE performance at a comparable total ADC bit budget. It should be understood that, generally, the receiver system of the present disclosure has N input antennas and P output (N×P MIMO receiver), while fully digital N×N MIMO has N input antennas and N outputs. The system considered in the numerical example presented here have 16 overall number of bits, and the bits are evenly distributed among the output channels. For the same targeted MSE performance floor, more than 4×quantization rate reduction is observed with the proposed method. FIG. 3 shows that quantization rate is reduced from 68 to 16 compared to fully digital MIMO which is more than 4× reduction. The conventional hybrid MIMO receiver, which only beamforms towards the desired angles and does not account for the interferers, also demonstrates worse recovery performance. Thus, the technique of the present disclosure provides 1.5× lower MSE at the same quantization rate of 16 bits, as shown in FIG. 3.

The optimization technique of the present disclosure (e.g. Process 1) provides for optimizing the analog combiner to reject the spatial interferers in analog, jointly optimized with the main system task of recovering the desired signals, s, in digital. The inventors model and compute the array factor (AF), illustrating the suppression of interferers in the spatial domain. The array factor is a measure of MIMO receiver gain as a function of an incoming signal's angular direction and defined as

$$A F ( θ ) = {\sum }_{i = 1}^{N} {A}_{i} {e}^{j π i s i n ( θ )} ,$$

where Aᵢ is a specific complex gain coefficient applied to the input signal, and N is the number of input antennas. For an N×P MIMO receiver, there would be P independent beams directed towards a specific angle.

The AF determined at the P=2 analog outputs of the receiver system of the present disclosure is illustrated in FIGS. 4A-4B and is compared with a task-agnostic conventional hybrid MIMO receiver whose analog combiner beamforms towards angle θ₁ (FIG. 4A) and angle θ₂ (FIG. 4B). The beam patterns achieved by the optimization Process 1 are directed towards both the desired angles θ₁ and θ₂, forming a linear combination of the desired signals at the output, while suppressing the interferers at angles ϕ₁, ϕ₂ by ≥36 dB. However, as observed in FIGS. 4A-4B, since the analog combiner is not only optimized for beamforming but rather designed for facilitating recovery from quantized observations, the optimized analog combiner of the present disclosure achieves lower AF gain for the desired signals compared to the conventional beamforming. Nonetheless, the lower AF gain does not harm the task-specific recovery accuracy (FIG. 3). Table 1 below summarizes the estimated power consumption comparison.

TABLE 1

| Hardware Component/System | Power (mW) |
|---|---|
| LNA/VM P_{LNA}/VM (1-5 GHz8 bit/4 bit) [14], [36] | 20/10 |
| Mixer with LO Gen (1-5 GHz) P_{MIX} [37], [38] | 15 |
| Baseband Amplifier P_{BB} [10] | 5 |
| ADC P_{ADC} (100 MS/s10 bit/4 bit) [39], [42] | 10/0.5 |
| Fully-Digital MIMO Receiver (8 × 8) | 520 |
| Conventional Hybrid MIMO Receiver (8 × 2) | 410 |
| Optimized Task-Specific Hybrid MIMO Receiver of the | 172 |
| present disclosure (8 × 2) | |

The inventors estimate the power consumption of the optimized task-specific HBF MIMO receiver of the present disclosure and the task-agnostic benchmark systems by using the measured power consumption of individual hardware components reported in the SOA integrated designs [5], [23].

Power consumption of an N×N fully-digital MIMO receiver is estimated by:

$${P}_{FD} = N \cdot {P}_{LNA} + N \cdot {P}_{MIX} + 2 \cdot N \cdot {P}_{BB} + 2 \cdot N \cdot {P}_{ADC} . \qquad ( 12 )$$

Here, P_{LNA} is the power consumed by a low-noise amplifier, P_{MIX} is the power of the mixer, and P_{BB} and P_{ADC} are baseband amplifier and ADC power consumption, respectively, doubled for I & Q paths.

The power consumed by an N×P hybrid MIMO receiver is estimated by:

$${P}_{HYB} = {γ}_{S P} \cdot N \cdot P \cdot {P}_{VM} + P \cdot {P}_{MIX} + 2 \cdot P \cdot {P}_{BB} + 2 \cdot P \cdot {P}_{A D C} . \qquad ( 13 )$$

Here, P_{VM} is the power consumed by a low-noise V_{M}-amplifier, and γ_{SP} is the analog combiner sparsity coefficient: γ_{SP}=1 denotes a non-sparse A, while γ_{SP}=0.75 corresponds to 25% sparsity. The estimated power consumption of each hardware component and the total power consumption of task-specific and task-agnostic MIMO receivers are summarized in Table 1. The power scaling for various quantization levels of the VMs is based on [24] when using 8 bits for high-resolution VMs. For the ADC power estimation, the inventors utilize Walden FoM [18].

The results show that the power-saving techniques according to the optimization approach of the present disclosure (e.g., 25% sparsity, 4-bit VMs, 4-bit ADCs) provide more than 58% reduction in power compared to the task-agnostic MIMO architectures using high-resolution ADCs, high-power LNAs, and high-resolution VMs. These notable power gains add to the improved MSE performance shown in FIG. 3 and the spatial interferer rejection observed in FIGS. 3A-4B.

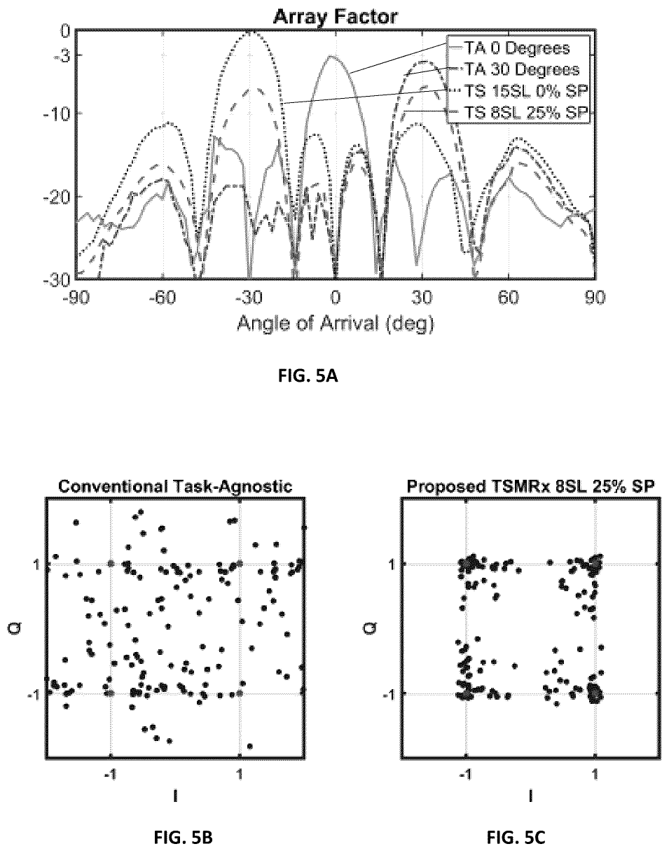

Reference is made to FIGS. 5A-5C showing the measurement/experimental results obtained by the inventors. FIG. 5A shows the measured array factor (in dB) for various task-agnostic and task-specific cases.

Array factors in FIG. 5A were measured for the following cases: (1) Task-Agnostic (TA) mode for 0° and +30° main beam angles and (2) Task-Specific (TS) cases for 15-SL 0% sparsity level (SP) modes with +30° main beam direction and arbitrary nulls at 0° and −50°. In addition, the 8-SL 25% SP case was purposefully configured for 2 desired signals at +30° and −30°, showing multi-beam performance at the single output in the presence of multiple SOI. Finally, EVM measurements were performed to demonstrate the signal recovery using low-bit ADCs in the presence of an interferer. A desired signal with a −55 dBm power level coming from the broadside and a blocker of −40 dBm coming from arbitrary +20° angle were generated at 1 GHz carrier frequency.

FIGS. 5B and 5C show measured Quadrature Phase Shift Keying (QPSK) constellation comparing the conventional task-agnostic approach (FIG. 5B) with the task-specific approach of the present disclosure (FIG. 5C). More specifically, FIGS. 5B and 5C show the task-specific recovery performance for a QPSK signal for the 8-SL 25% SP case using 2-bit ADCs compared to an unsuccessful recovery for a conventional task-agnostic approach under the same hardware conditions.

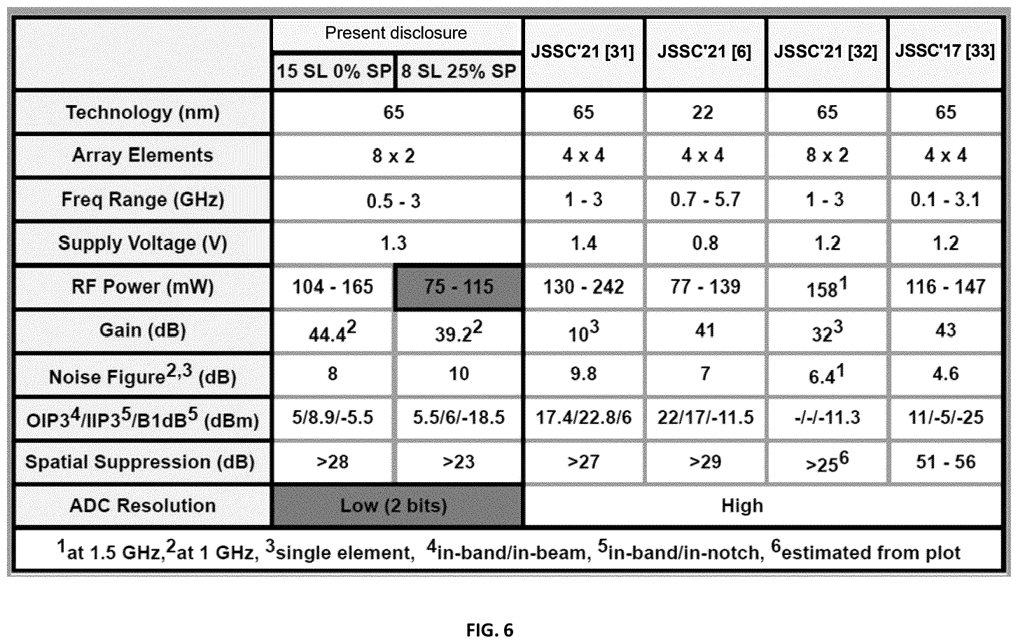

The summary table is shown in FIG. 6 which compares the performance of the task-specific receiver system of the present disclosure exemplified above to the state-of-the-art approach, as described in references [31], [6], [32], [33]. The lowest power consumption, relative to the similar technology node described in the literature, is achieved in 8-SL 25% SP mode with comparable noise figure, while 15-SL 0% SP mode shows good linearity and blocker tolerance. Both modes of operation enable signal acquisition with only 2-bit ADC resolution.

Thus, the present disclosure provides an optimized hybrid MIMO receiver system with embedded beamforming and low-resolution ADCs using task-specific quantization. The technique of the present disclosure also preferably utilizes a power-efficient analog and digital joint optimization framework, incorporating sparse analog combining and considering the finite resolution of the configurable analog pre-processing hardware. Furthermore, the optimized receiver system of the present disclosure demonstrates suppression of undesired spatial interferers to facilitate operation in congested spectrum environments. Supported by the numerical simulation results presented above, the optimized hybrid MIMO receiver system notably outperforms the task-agnostic MIMO receivers by achieving optimal MSE performance at lower power and lower quantization rate.

1. A multiple-input multiple-output (MIMO) receiver system associated with N antennas, the receiver system comprising:
an analog combiner assembly comprising a matrix of vector modulators configured for coupling to said N antennas, said analog combiner assembly being configured and operable to controllably apply gain and phase shift to each of N signals being received from the respective antenna and combine said N signals into P corresponding signals, P<N;
an ADC assembly comprising an array of ADC units, each configured for performing quantization of a respective one of said P corresponding signals with a predetermined bit constrain;
a signal recovery system comprising: a digital signal processor configured to perform task-specific recovery of selected K signals associated with predetermined input directions to which the N antennas are exposed from quantized and filtered digital representation of the N signals being received by the analog combiner assembly; and a control unit, wherein
said control unit is configured and operable to utilize optimized operational data to operate the analog combiner and the digital signal processor, wherein said optimized operational data is indicative of optimized values of the phase shifts, such that said digital signal processor utilizes said optimized values of the phase shifts to perform said task-specific signal recovery under a condition of minimal value of a mean square error characteristic minimizing a difference between said digital representation of the signals being received by the analog combiner assembly and said selected K signals.

2. The receiver system according to claim 1, characterized by least one of the following:
said optimized operational data of the matrix of the vector modulators provides that said quantized and filtered digital representation of the N signals is characterized by rejection of undesired signals incident on the N antennas and corresponds only to the selected K signals associated with the predetermined input directions to which the N antennas are exposed; and
said optimized operational data is further indicative of an optimized sparsity level of deactivation of said matric of vector modulators, said digital signal processor utilizing said optimized sparsity level of deactivation during said task-specific signal recovery, such that power consumption is reduced.

3. (canceled)

4. The receiver system according to claim 1, wherein said array of ADCs comprises P complex ADCs, each of the ADCs comprising in-phase and quadrature-phase quantization channels, the array of the ADCs thereby defining 2P quantization channels.

5. The receiver system according to claim 1, characterized by at least one of the following:
said control unit is configured and operable to communicate with a signal recovery optimizer to receive therefrom and store said optimized operational data, and
the control unit comprises a signal recovery optimizer configured and operable to generate said optimized operational data.

6. (canceled)

7. The receiver system according to claim 1, wherein the control unit comprises a signal recovery optimizer configured and operable to generate said optimized operational data, the signal recovery optimizer is being configured and operable to utilize input data, which comprises system data and comprises measured data indicative of said N signals being received, and utilize predetermined task-specific data defined by said condition of the minimal value of the mean square error, to perform an optimization process and determine at least the optimized values of the phase shifts, and generate the optimized operational data for the analog combiner and the digital signal processor.

8. The receiver system according to claim 7, characterized by at least one of the following:
the signal recovery optimizer is further configured and operable to utilize said input data and said predetermined task-specific data to perform the optimization process and determine the optimized values of the phase shifts and optimized sparsity level of deactivation of said matrix of vector modulators, and generate the optimized operational data for the analog combiner and the digital signal processor;
the signal recovery optimizer is configured and operable to iteratively determine at least the optimized values of the phase shifts via iterative tuning of said values, to thereby determine the optimized operational data satisfying the condition of MSEₘᵢₙ; and
the system data comprises: number N of the antennas, number P of the ADCs and a value b or said predetermined bit constrain defining a quantization resolution of ADC, a matrix arrangement N×P of said matrix of vector modulations, and angles of arrival θ₁, . . . , θ_{K} and power level of said K signals, and angles ϕ₁, . . . , ϕ_{M} of arrival of M undesired signals to be rejected.

9. (canceled)

10. (canceled)

11. The receiver system according to claim 192, wherein the signal recovery optimizer is configured and operable to iteratively determine at least the optimized values of the phase shifts via iterative tuning of said values, to thereby determine the optimized operational data satisfying the condition of MSEₘᵢₙ, said iterative tuning being implemented via convex optimization processing to satisfy said condition for the MSE defined as:
$$M S E ( A ) : = E \{ {‖ s - E \{ s \vert {Q}_{b} ( A x ) \} ‖}^{2} \}$$
where E{s|Q_{b}(Ax)} is conditional expectation value of a signal vector s of said selected K signals having the digital representation Q_{b}(Ax), wherein said convex optimization is performed over discrete values in a parametric space of phase shifts performed by the vector modulators, thereby performing discrete optimization aimed at minimizing overall loss measure L(A) of the analog combiner.

12. The receiver system according to claim 7, wherein the signal recovery optimizer is configured and operable to iteratively determine at least the optimized values of the phase shifts via iterative tuning of said values, to thereby determine the optimized operational data satisfying the condition of MSEₘᵢₙ, the signal recovery optimizer being further configured and operable to iteratively determine optimized sparsity level of deactivation of the vector modulators via iterative tuning of said sparsity level, to thereby determine the optimized operational data satisfying the condition of MSEₘᵢₙ.

13. The receiver system according to claim 7, wherein the signal recovery optimizer is configured and operable to iteratively determine at least the optimized values of the phase shifts via iterative tuning of said values, to thereby determine the optimized operation data satisfying the condition of MSEₘᵢₙ, the signal recovery optimizer being configured as a computer system comprising input and output utilities and a data processor and analyzer utility, said data processor and analyzer utility comprising: an analog combiner controller comprising a beamforming optimizer, and a task controller, wherein the task controller is configured and operable to determine, for each signal being received, a value of the mean square error, and the beamforming optimizer is configured and operable to operate together with the task controller to iteratively determine the optimized values of the phase shifts via the iterative tuning of said values, to thereby determine the optimized operational data satisfying the condition of MSEₘᵢₙ.

14. The receiver system according to claim 13, wherein said data processor and analyzer utility of the signal recovery optimizer further comprises a power optimizer configured and operable to operate together with the task controller to iteratively determine the optimized sparsity level via the iterative tuning of said sparsity level utilized in determination of the optimized operational data.

15. A signal recovery optimizer for optimizing operation of a multiple-input multiple-output (MIMO) receiver system which is associated with N antennas and which comprises an analog combiner formed by a matrix of vector modulators and comprises an array of ADCs performing signal quantization with a predetermined bit constrain, and is configured to perform hybrid analog-digital beamforming of N signals being received and corresponding to K desired signals arriving to the antennas with predetermined angles from respective desired sources, and perform signal recovery of said K signals, said signal recovery optimizer comprising a computer system configured and operable to utilize input data, comprising system data, measured data indicative of the N signals being received, and predetermined task-specific data defined by a task-specific condition of a minimal value of a mean square error characteristic minimizing a difference between digital representation of the signals being received by the analog combiner assembly and said K desired signals, and perform an iterative optimization process to determine optimized operational data for said analog combiner indicative of at least optimized values of phase shifts, thereby enabling the signal recovery of said K signals while optimizing performance of the antenna receiver by suppressing effect of undesired M interferers arriving to the antennas.

16. The signal recovery optimizer according to claim 15, wherein the system data comprises: number N of the antennas, number P of the ADCs and a value b of said predetermined bit constrain defining a quantization resolution of the ADC, a matrix arrangement N×P of said matrix of vector modulators, and angles of arrival θ₁, . . . , θ_{K} and power level of said K desired signals, and angles ϕ₁, . . . , ϕ_{M} of arrival of said M undesired signals.

17. The signal recovery optimizer according to claim 15, wherein the computer system is configured and operable to iteratively determine the optimized values of the phase shifts via iterative tuning of said values to thereby determine the optimized operational data satisfying the condition of MSEₘᵢₙ.

18. The signal recovery optimizer according to claim 15, wherein said computer system is further configured and operable to perform iterative optimization process for a sparsity level of deactivation of the vector modulators, such that the optimized operational data is further indicative of optimized sparsity level of deactivation, thereby reducing power consumption of the analog combiner.

19. The signal recovery optimizer according to claim 18, configured and operable to iteratively determine the optimized sparsity level via iterative tuning of said sparsity level.

20. The signal recovery optimizer according to claim 17, wherein said iterative tuning is implemented via convex optimization processing to satisfy said condition for the MSE defined as:
$$M S E ( A ) : = E \{ {‖ s - E \{ s \vert {Q}_{b} ( A x ) \} ‖}^{2} \}$$
where E{s|Q_{b}(Ax)} is conditional expectation value of a signal vector s of said K desired signals having the digital representation Q_{b}(Ax), wherein said convex optimization is performed over discrete values in a parametric space of phase shifts performed by the vector modulators, thereby performing discrete optimization aimed at minimizing overall loss measure L(A) of the analog combiner.

21. The signal recovery optimizer according to claim 17, wherein the computer system comprises input and output utilities and a data processor and analyzer utility, said data processor and analyzer utility comprising: an analog combiner controller comprising a beamforming optimizer, and a task controller, wherein the task controller is configured and operable to determine, for each signal being received, a value of the mean square error, and the beamforming optimizer is configured and operable to operate together with the task controller to iteratively determine the optimized values of the phase shifts via the iterative tuning of said values, to thereby determine the optimized operational data satisfying the condition of MSEₘᵢₙ.

22. The signal recovery optimizer according to claim 21, wherein the data processor and analyzer utility further comprises a power optimizer configured and operable to operate together with the task controller to iteratively determine optimized sparsity level via iterative tuning of said sparsity level.

23. The signal recovery optimizer according to claim 15, configured and operable to connect to the antenna receiver to perform a learning session and determine the operational data.

24. The signal recovery optimizer according to claim 15, configured and operable for communication with a control unit of the antenna receiver to communicate the operational data to be stored in the control unit.
